(19) United States
(12) Patent Application Publication
(10) Pub. No.: US 2003/0191823 A1
(43) Pub. Date: Oct. 9, 2003

(54) System and method for providing customizable device capabilities to network equipment in a non-service affecting manner

(75) Inventors: Rajnish Kumar Bansal, New Delhi (IN); Michael Steven Holloway, Hillsborough, NJ (US)

Correspondence Address: Victor F. Souto, Hale And Dorr LLP, 650 College Road East, Princeton, NJ, 08540, US

(73) Assignee: Aplion Networks, Inc., Edison, NJ

(21) Appl. No.: 10/114,245

(22) Filed: Apr. 3, 2002

(51) Int. Cl. G06F 15/177

(52) U.S. Cl. 709/220

(57) ABSTRACT

A system and method for employing a remote management application to distribute so-called “service bundles” to network devices in a manner that allows capabilities provided to be discerned exactly, activating only those service capabilities desired remotely and without disrupting existing services provided on the network devices. In so doing, the system and method of the present invention allows for economic usage of memory on the network devices. The system and method of the present invention can be employed in all sizes of network devices and the software embodying new service capabilities is deployed on one or more network devices themselves and on a management workstation.

### FIELD OF THE INVENTION

This invention relates to a system and method for customizing network equipment in a network and, more particularly to a system and method that allows a network to provide selective, customizable services capabilities to network devices without disrupting the services provided by the network equipment.

### BACKGROUND OF THE INVENTION

The widespread proliferation of voice and data networks of all kinds, including but not limited to, the Internet, intranets, virtual private networks, the public switched telephone network, etc., have resulted in the proliferation of equipment and devices (hereafter “network devices”) to enable voice and data communications via these networks. These networks can be, for example, wire-line, wireless, microwave, satellite, etc. Examples of network devices include, but are not limited to, routers, switches, hubs, firewalls, set-top boxes, Internet or information appliances, residential gateways, PCs, etc. These networks are typically maintained by various entities including, but not limited to, traditional telephony carriers, Internet service providers, corporations, etc., hereafter referred to as “service providers.” Each of the networks discussed above can be centralized or distributed so that the network devices may be located in many places, including on the premises of customers.

Each service provider faces the same issues when it comes time to correct, update, or enhance the capability of their networks—how to do so without disrupting network operation and in the most cost-effective manner. Traditionally, vendors of network devices implemented new capabilities or services for network devices by providing new versions of software, which are commonly referred to as generics, builds or loads, that were installed on the network device by the vendor directly or by the service provider. The installation in some cases was done remotely using a known method for distributing software to remote network devices in a distributed network such as Remote Software Downloading using a conventional File Transfer Protocol. Alternatively, the service provider or vendor would dispatch a technician to travel to the one or more network devices to load the new software directly onto the network devices. In both cases, the network devices would be taken “off-line” prior to or after the new software was loaded and then reset before the new software could be functional.

The foregoing method of software deployment typically was done as a new version of software for the network devices. Under this scenario, as new features and capabilities were added to the software, larger and larger software files were created to accommodate these new features and capabilities. Over time, the software files could grow so large that they would be too large for the memory capacity of the network devices. As a result, additional memory would be added to the network devices or, if additional memory could not be added, the network devices would be replaced with devices that had more memory capacity. The service providers or customers would be required to put in this time and expense even in situations where not all of the features and capabilities that were added in the new software update were needed by each one of the network devices being updated. This wholesale update strategy did not provide service providers or customers with any easy way to account for and deploy discernible service customizations so that different service options could be provided to network devices.

Based on the foregoing, it is easy to deduce that scenarios where a network service option requires deploying or updating service customizations on more than one network devices at the same time would be both very expensive and highly error prone.

Recent advancements have led to the emergence of a technology initiative called the Open Services Gateway Initiative (“OSGi”). OSGi focuses on creating open specifications for the delivery of service customizations to network devices. An OSGi Service Platform Specification was first released in May 2000. The specification delivers an open, common architecture for service providers, developers, software vendors, gateway operators and equipment vendors to develop, deploy and manage the service customizations.

Sun Microsystems, Inc. of Mountain View, Calif. has developed an implementation of the OSGi Service Framework (as described in the OSGi specification), which it calls a “Java Embedded Server” (“JES”). JES provides a general-purpose Java framework that supports the deployment of downloadable service customizations known as bundles. The network devices having OSGi Service Framework on them can download and install OSGi bundles, and remove them when they are no longer required. The OSGi Service Framework manages the life cycle of bundles.

The OSGi Service Framework strategy is essentially only “network device” centric (and not “network” centric). It does not describe a remote management solution that enables a service provider to deploy and manage services spread across network devices remotely from a network perspective. It also requires a service provider to build a service management system completely from scratch, which in turn would require a fair amount of time and expense. Therefore, OSGi does not address the problem of services deployment and management in large networks.

### SUMMARY OF THE INVENTION

The present invention is directed to a system and method for distributing so-called “service bundles” to network devices in a manner that allows capabilities provided to be discerned exactly, activating only those service capabilities desired remotely and without disrupting existing services provided, and upgrading existing service capabilities remotely without disrupting other existing service capabilities on the network devices. In so doing, the system and method of the present invention allows for economic usage of memory on the network devices.

The present invention is optimally deployed in a large network of network devices to manage network devices (e.g., auto-discovery of network devices, monitoring of network devices' operations status, etc.), to distribute “service bundles” to network devices, to distribute “network services” where a single network service comprises several “service bundles” destined for different network devices simultaneously (in order to realize a single network service), and to manage services life cycles.

The system and method of the present invention can be employed in all sizes of network devices. In at least one exemplary embodiment, the software embodying “service capabilities” is deployed on one or more network devices themselves and the software embodying “management capabilities” is deployed on a management system. When deployed on a network device, the present invention is used to host a service that provides some capability to the network device. Similarly, when deployed on a management system, the present invention is used to host a service that provides management functionality of the management system.

In addition, the present invention, when deployed on a management system, is also used to deploy a “network service” that may be spanning across multiple network devices. The present invention is used to deploy several “service bundles” simultaneously on different network devices, which combine to comprise a single usable “network service.” One example of such a network service is Quality of Service (QoS), which comprises at least two separate deployable “service bundles” that are deployed on at least two end-points (network devices), respectively, in the network to offer service provider's customers an end-to-end QoS service.

In a first embodiment, there is disclosed a method for enabling the receipt and activation of service capabilities by a plurality of network devices that operate in a network to provide a plurality of services to at least one network user. The method comprises the steps of (1) receiving a notification at the plurality of network devices that at least one service bundle is available, the service bundle including the service capability for deployment on the plurality of network devices, (2) receiving the at least one service bundle at the plurality of network devices without disrupting the plurality of services operating on the plurality of network devices, and (3) activating the service capability on the plurality of network devices so that the service capability is available to the at least one network user without disrupting the operation of the plurality of services operating on the plurality of network devices.

In another embodiment of the present invention, a method for providing service capabilities to a plurality of network devices is disclosed. The plurality of network devices operates in a network to provide a plurality of services to at least one network user. The method comprises the steps of (1) transmitting a notification to the plurality of network devices that at least one service bundle is available, the service bundle including a service capability for deployment on the plurality of network devices, (2) transmitting the at least one service bundle at the plurality of network devices without disrupting the plurality of services operating on the plurality of network devices, and (3) instructing the plurality of network devices to activate the service capability on the plurality of network devices so that the service capability is available to the at least one network user without disrupting the operation of the plurality of services operating on the plurality of network devices.

In yet another embodiment of the present invention, a method for activating a service capability by a service management system is disclosed. The service management system operates in a network and manages a plurality of network devices. The service management system provides a plurality of services to at least one network user. The method comprising the steps of receiving at least one service bundle at the service management system without disrupting the plurality of services operating on the service management system, the service bundle including the service capability for activation on the service management system and activating the service capability on the service management system so that the service capability is available to the at least one network user without disrupting the operation of the plurality of services operating on the service management system.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated exemplary embodiments of the invention.

Other objects of the present invention will be evident to those of ordinary skill, particularly upon consideration of the following detailed description of exemplary embodiments.

### BRIEF DESCRIPTION OF THE DRAWINGS

FIG. 1 illustrates an exemplary architecture for the present invention.

FIG. 2 illustrates an exemplary network environment for deploying the present invention.

FIG. 3 illustrates an exemplary embodiment of a service bundle packaging.

FIG. 4 illustrates a plurality of state transitions for a service bundle.

FIG. 5 illustrates an exemplary process for an “INSTALL” operation according to the present invention.

FIG. 6 illustrates an exemplary process for an “START” operation according to the present invention.

FIG. 7 illustrates an exemplary process for an “STOP” operation according to the present invention.

FIG. 8 illustrates an exemplary process for an “REINSTALL” operation according to the present invention.

FIG. 9 illustrates an exemplary process for an “UPGRADE” operation according to the present invention.

FIG. 10 illustrates an exemplary process for an “UNINSTALL” operation according to the present invention.

FIG. 11 illustrates an exemplary process for an “INVOKEMETHOD” operation according to the present invention.

FIG. 12 illustrates an exemplary network environment for deploying the present invention with one Service Management System and multiple network devices.

FIG. 13 illustrates an exemplary network environment for auto-discovery of network devices and determination of operational status of network devices and services installed on network devices by a SMS.

### DETAILED DESCRIPTION

In the following detailed description, numerous specific details are set forth regarding the system and method and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

The present invention, which is sometimes referred to herein by the name “Active Framework,” provides the basic service deployment infrastructure that can be used by a service deployment system and a plurality of network devices in a network to deploy services remotely to a plurality of network devices. Examples of network devices include, but are not limited to, network devices that are marketed and sold under the names Soloist and Duet, which are available from Aplion Networks, Inc. of Edison, N.J., and also routers, switches, hubs, firewalls, set-top boxes, Internet or information appliances, residential gateways, PCs, etc. The present invention enables so-called life-cycle management of services remotely by a Service Management System (“SMS”). The SMS provides life-cycle management of services that are deployed on a plurality of network devices. An example of a SMS includes, but is not limited to, the Maestro platform, which is also available from Aplion Networks.

In the context of the present invention, the following definitions apply to certain terms that are used throughout the specification. An embedded service is a service bundle that is deployable on any single network device. A network service is a service bundle that comprises at least two service bundles (embedded services) destined to be deployed on at least two different network devices to realize a single service option for at least one network user. A management-service is a service that is deployed on the SMS and is responsible for managing the instances of an embedded service or a network service that are deployed on network devices.

The “Active Framework” system and method of the present invention provides a hosting environment for hosting the services, which can be installed, activated, configured, upgraded, downgraded, deactivated, uninstalled, etc. within this hosting environment. Any kind of service (e.g., embedded service, management-service, etc.) can be hosted in this environment. Examples of these services include, but are not limited to, Stream Management, Virtual Private Network, Firewall, Dynamic Host Configuration Protocol (“DHCP”), etc.

A service (or “Active Framework compliant service” ) is a self-contained software component that preferably conforms to a well-defined specification in that it needs to provide or implement one or more hooks (e.g., a well-defined “method” or a “callback method”) and is intended to be called or invoked by Active Framework for the purpose for which it is intended, e.g., customization of a service install operation. The service can be deployed on network device. Active Framework does not impose any restrictions on the functionality that a service can implement. A service can implement certain functionality and expose one or more “Application Programming Interfaces” (APIs) that allow configuration of the implemented functionality.

Note that in the context of the present invention, a service can either be implemented as a set of Java classes, or alternatively, it can be implemented as a set of native modules (.o files for VxWorks, .so files for Solaris/Unix, .dll files for the Windows NT operating system, which is a available from the Microsoft Corporation of Redmond, Wash., etc.) and then wrapped by a set of Java wrapper classes to make it an Active Framework compliant service. It should be apparent to one skilled in the art that the services can be implemented readily in any number of ways.

An Active Framework compliant service is packaged in a “bundle” (explained below) so that it can be deployed in the hosting environment offered by the present invention. The Active Framework system and method of the present inventions hosts services that are packaged as bundles, which are containers (in one exemplary embodiment it is a “JAR” file) that includes executable as well as non-executable resources for a service. An exemplary bundle comprises Java class files, native library files, and can also contain non-executable resources for the service, such as HTML files or GIF files. The bundle also includes a manifest file that itself includes special headers that describe the bundle (and the contained service) to the Active Framework system and method. The headers also state whether the contained service is dependent upon other services. A bundle may optionally contain the bundles for these dependent services.

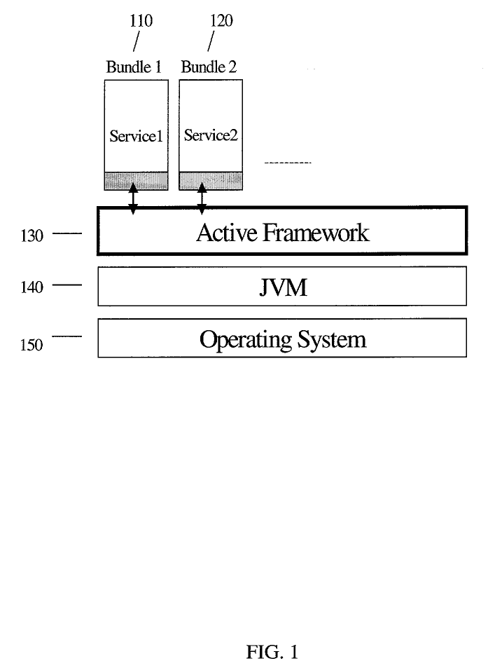

Referring now to the drawings, and initially to FIG. 1, there is illustrated an exemplary architecture for the present invention. The illustrated embodiment is written in Java language and it preferably runs on a Java Virtual Machine (hereafter “JVM”). As illustrated in FIG. 1, Active Framework provides the hosting environment within which services run. It should be understood by those skilled in the art that while the exemplary embodiment is implemented in Java, it could just as easily be implemented in any one of a number of other programming languages, including but not limited to, C, C++, Ada, Smalltalk, Modula 2, Prolog, LISP, Pascal, Assembly, etc. The services can be installed, activated, configured, upgraded, downgraded, deactivated, uninstalled, etc., within this hosting environment. Deployed services can query for existence of other services within the hosting environment and use them as desired, etc.

Active Framework provides a hosting environment in that it performs life-cycle operations on Active Framework compliant services. Even though services essentially run in the JVM (or on the underlying operating system), they run in the context of Active Framework and can use Active Framework for querying for other existing services and use those existing services to extend the functionality of services.

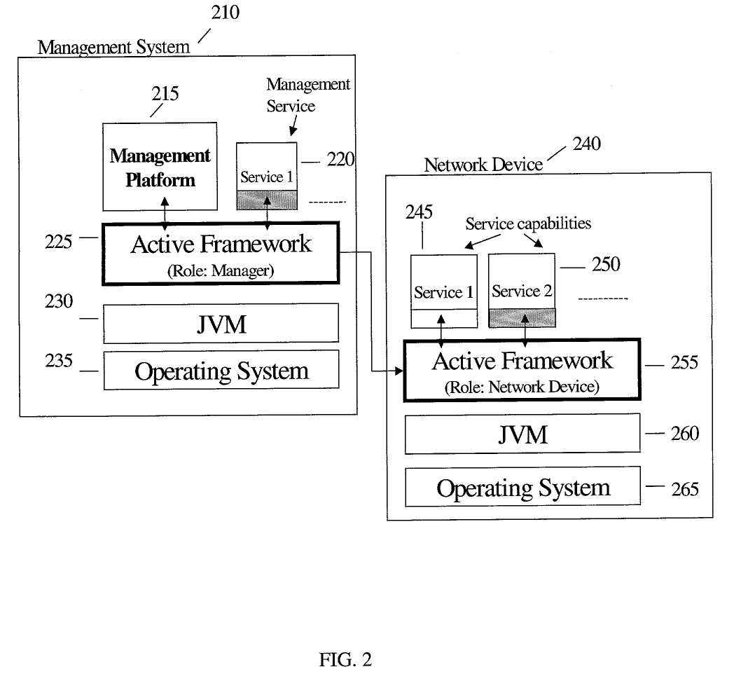

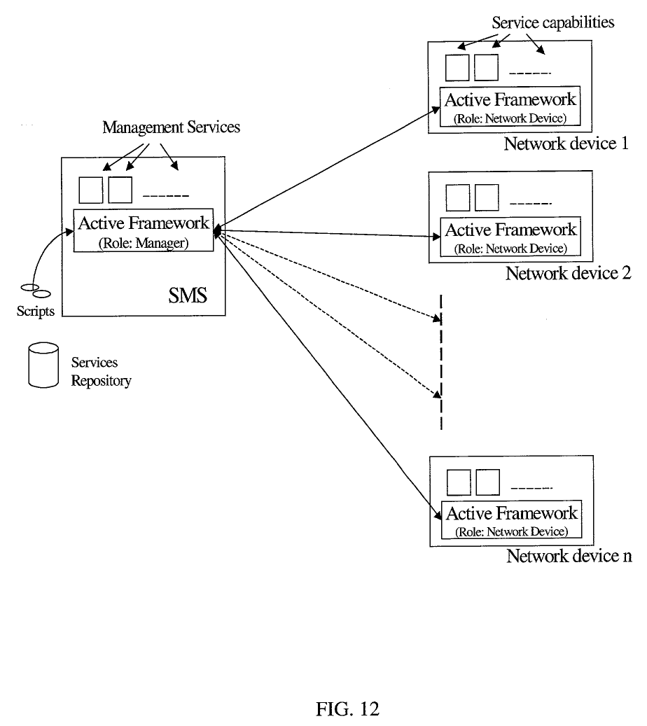

In addition to providing a service hosting environment, referring to FIG. 2 and FIG. 12, Active Framework can function in two different roles—as a service gateway (referred to as “Network device” in the figures for simplicity) and as an infrastructure manager (referred to as “Manager” in the figures for simplicity). Active Framework, when resident on a network device, is running in a service gateway role. Active Framework, when running as part of a SMS, is running in an infrastructure manager role.

In its role as a service gateway, Active Framework can be informed about the existence and the identity of a SMS. Active Framework uses this knowledge to let the SMS know when a network device comes up and sends the SMS additional information about the network device upon which it is resident. This mechanism helps the SMS to auto-discover network devices dynamically and to know about the operational (UP/DOWN) status and other information about the network device. The “auto-discovery” and “determining operational status” mechanisms are further described below in the sections entitled “Auto-Discovery Of Network Devices By A SMS” and “Determination Of Operational Status Of Network Devices And Services By A SMS.”

In its role as an infrastructure manager, Active Framework maintains connection information about other network devices (Active Framework instances running on network devices in the role of service gateway as described above) that helps the SMS know about the existence of network devices and communicates with them for dynamic service deployment and life-cycle management operations.

FIG. 2 illustrates a high-level architectural view of a SMS that uses Active Framework as the underlying infrastructure for its service-hosting environment, dynamic service deployment and life-cycle management functionality. The SMS uses Active Framework to communicate with network devices for various purposes, as well as to host management services. Management services use Active Framework to deploy embedded services and network services on network devices and to perform life-cycle management operations on them. The network devices use Active Framework to host embedded services, which can then be managed by the SMS.

The Active Framework system and method enables a SMS to perform the following functions on the SMS and a plurality of network devices: (1) install a service, (2) uninstall a service, (3) start a service, (4) stop a service, (5) upgrade a service, (6) downgrade a service, (7) reinstall a service and (8) configure a service (e.g., get/set service attributes, add rules/policies, etc.).

Active Framework also enables a local or remote management application (e.g., SMS) to register/unregister its interest in certain events such as (1) an Active Framework event, e.g., when Active Framework starts, before Active Framework is shutdown, when some error in Active Framework occurs, etc., (2) service life-cycle events, e.g., when a service is installed by Active Framework, when a service is upgraded by Active Framework, before a service is uninstalled by Active Framework, when a service is started by Active Framework, before a service is stopped by Active Framework, etc. and (3) service specific events, e.g., any service-specific events that may be generated by the service contained inside a bundle such as alarms, error conditions, etc. (e.g., service out of memory, counter overflow, etc.)

In addition, Active Framework enables a local or remote management application (e.g., SMS) to query for (1) the list of installed services with “detailed service information,” (2) detailed service information for a given service and (3) a list of installed services with operational state information for the services (e.g., Service Id, Service Name, Service Version, Operational State, etc.). The detailed service information includes Service Id, Service Name, Version, Service URL, JAR file destination location, JAR file name, absolute JAR file name, various hooks, etc. The foregoing information allows a remote management application to display the information in its user interface to a user of the application, synchronize the states information that it may have cached, etc.

Active Framework also enables a remote management station to (1) get Active Framework version number, (2) restart Active Framework, (3) get equipment information such as equipment type, equipment software version number, equipment hardware version number, etc. and (4) reboot the equipment. These operations are explained below.

As explained above, in the context of the present invention, a bundle contains executable as well non-executable resources for a service. In one exemplary embodiment, a bundle is deployed as a JAR file and includes a manifest file that includes special headers that describe the bundle to Active Framework. The headers specify information such as service name, service upgrade/downgrade information, various hooks (which are explained later) that allow customization of operations on a contained service, etc.

The following is an example of a manifest file for an embedded service bundle called “Firewall.”

ServiceName: Firewall

ServiceVersion: 2.1

ServiceType: Embedded

InstallerHook: com.aplion.firewall.Installer

ReinstallerHook: com.aplion.firewall.Reinstaller

UninstallerHook: com.aplion.firewall.Uninstaller

ActivatorHook: com.aplion.firewall.Activator

UpgraderHook: com.aplion.firewall.Upgrader

AboutHook: com.aplion.firewall.About

MainClass: com.aplion.firewall.Configurator

SupportedEquipments: Soloist, 1.0

UpGradeFrom: 2.0

DownGradeTo: 2.0

The following is an example of a manifest file for a network service bundle called “End-to-end QoS.” The service comprises two embedded services called “SoloistQoS” and “OrchestraQoS,” each destined for two different kinds of exemplary network devices—Soloist and Orchestra (manufactured by Aplion Networks Inc. of Edison, N.J., the assignee herein), respectively. Each embedded service is referred to as a “Service Fragment” in this manifest file.

ServiceName: End-to-end QoS

ServiceVersion: 2.4

ServiceType: Network

NumberofServiceFragments=2

ServiceFragment1=Name:SoloistQoS;Version:2.4;EquipmentType:Soloist

ServiceFragment2=Name:OrchestraQoS;Version:2.4;EquipmentType:Orchestra

UpGradeFrom: 2.3

DownGradeTo: 2.3

The following table describes the various exemplary fields of the manifest header:

TABLE 1
Manifest Headers

| Manifest Header | Header Type | Description |
|---|---|---|
| ServiceName | String | Specifies the name of contained service |
| ServiceVersion | String | Specifies the version of the service in dotted |
| | | form in format <major.minor> where |
| | | “major” specifies major version number and |
| | | “minor” specifies minor version number. |
| ServiceType | String | Specifies the type of the service. Exemplary |
| | | values are: |
| | | Embedded: Specifies the service bundle |
| | | contains the resources for an embedded |
| | | service. |
| | | Network: Specifies the service bundle |
| | | contains the resources for a network service. |
| | | Management: Specifies the service bundle |
| | | contains the resources for a management |
| | | service. |
| NumberOfService | Numeric | Specifies the number of service fragments |
| Fragments | | (embedded services) this service contains. |
| | | This field is applicable only if the |
| | | ServiceType is “Network.” |
| ServiceFragment<n> | String | Specifies the attributes of the nth service |
| | | fragment. This field is applicable only if the |
| | | ServiceType is “Network.” The service |
| | | attributes included are: ServiceName, |
| | | ServiceVersion and EquipmentType. |
| EquipmentType | String | Specifies the type of network equipment |
| | | (network device) to which the embedded |
| | | service is destined. The exemplary values |
| | | are Soloist, Duet, Orchestra, etc. |
| InstallerHook | Class- | Specifies the class for Installer hook for the |
| | name | bundle |
| ReinstallerHook | Class- | Specifies the class for Reinstaller hook for |
| | name | the bundle |
| UninstallerHook | Class- | Specifies the class for Uninstaller hook for |
| | name | the bundle |
| ActivatorHook | Class- | Specifies the class for Activator hook for the |
| | name | bundle |
| UpgraderHook | Class- | Specifies the class for Upgrader hook for |
| | name | the bundle |
| AboutHook | Class- | Specifies the class for About hook for the |
| | name | bundle |
| MainClass | Class- | Specifies the class that provides an object |
| | name | implementing methods permitting |
| | | configuration of the service |
| Bundle- | String | A URL that specifies the location from |
| UpdateLocation | | where upgrades for the bundle can be found |
| | | in future |
| UpGradeFrom | String | List of service versions that can be |
| | (,String)* | upgraded with this service. |
| DownGradeTo | String | List of service versions to which the service |
| | (,String)* | can be downgraded. |
| SupportedEquipments | (String [, | A semicolon separated list of |
| | String]*); | EquipmentName [Supported Equipment |
| | (String [, | Version]* entries. Each entry in the list |
| | String]*)* | specifies the name and versions of the |
| | | equipment on which this service can be |
| | | installed. The item enclosed in brackets is |
| | | optional. The item marked with an asterisk |
| | | can have zero or more entries. |

The relationship between the Active Framework and its installed services (also known as “Active Services” in the terminology of exemplary embodiment) is captured by the notion of a descriptor object called “Active Service Descriptor” (“ASD” hereafter). An ASD is an object that represents an installed service. Once a service is installed in Active Framework, a unique ASD can be obtained for it. This ASD implements methods, described below in the “Queries Support” section, that enable querying for service properties including Service Id, Name, Version, JAR file name, JAR file destination location, etc.

Bundle Hooks

A “hook” establishes one or more interfaces between the service contained in a bundle and Active Framework. A hook can be viewed as a well-defined specification of the interfaces provided by the service so that any external entity or application (e.g., Active Framework in this case) can perform certain operations on the service for which the hook is intended. Active Framework uses the hooks to customize or perform life-cycle operations on the service. In at least one embodiment, each hook is defined by an interface in the Java programming language. It should be understood by those skilled in the art that other programming languages could be used.

Active Framework defines hooks that can be implemented by a bundle writer. In this context, a bundle writer is the person responsible for creating the service bundle. The particular hooks that are implemented for a particular service by the bundler writer are described in the manifest file of the service bundle.

A bundle writer can implement a number of exemplary hooks. They include (1) an optional “Installer hook” to control the installation of the service bundle, (2) an optional “Reinstaller hook” to control the re-installation of the service bundle, (3) an optional “Uninstaller hook” to control the un-installation of the service bundle, (4) an “Activator hook” to control the activation and deactivation of the service bundle, (5) an optional “Upgrader hook” to control the upgrade/downgrade of the service bundle, (6) an optional “About hook” to provide optional information about the bundle and its service, such as the name, description, version number, etc. and (7) a “Configurator hook” to encapsulate a configuration object that allows access to all configuration APIs for the service that the bundle contains.

Set forth below are exemplary specifications for the interfaces that a bundle writer may use to implement a particular hook with a bundle.

Installer Hook Interface

The Installer hook interface comprises methods to customize the installation of a service bundle. Preferably, a bundle writer implements this interface only if he or she wishes to perform some additional installation related functions not performed by default during the installation process by Active Framework. This interface includes the following exemplary method.

public boolean install(iActiveServiceDescriptor descriptor) throws OperationAbortedException, OperationFailedException;

If the bundle in question implements this method, Active Framework invokes it during the installation process to override the alternate or default installation steps that would otherwise be performed if the hook was not present.

Reinstaller Hook Interface

The Reinstaller hook interface comprises methods to customize the reinstallation of a service bundle. Preferably, a bundle writer implements this interface only if he or she wishes to perform some additional re-installation related functions that are not performed by default during the reinstallation process by Active Framework. This interface includes the following exemplary method.

public boolean reinstall (URL nextURL, Object param) throws OperationAbortedException, OperationFailedException;

If the bundle in question implements this method, Active Framework invokes it during the re-installation process to override any alternate or default re-installation steps that would otherwise be performed if the hook was not present.

Uninstaller Hook Interface

The Uninstaller hook interface includes methods to customize the uninstallation of a service bundle. Preferably, a bundle writer implements this interface only if he or she wishes to perform some additional uninstallation related functions that are not performed by default during the uninstall process by Active Framework. This interface includes the following exemplary method.

public boolean unInstall(iActiveServiceDescriptor descriptor) throws OperationAbortedException, OperationFailedException;

If the bundle in question implements this method, Active Framework invokes it during un-installation process to override any alternate or default un-installation steps that would otherwise be performed if the hook was not present.

Activator Hook Interface

In at least one embodiment of the present invention, the Activator hook interface is a preferably required interface for a bundle. The Active Framework process invokes these methods while starting and stopping the bundle. This interface includes the following exemplary method.

public boolean start(iActiveServiceDescriptor descriptor);

This “start” method is called when it is desired to start the service so that the service can perform any service specific activities needed to start the service. Bundle writers may use this method to perform any service specific functions at startup such as loading native binaries, performing necessary module initialization, etc. The foregoing method preferably completes and returns control to the Active Framework application in a timely manner.

public boolean stop(iActiveServiceDescriptor descriptor);

This “stop” method is called when it is desired to stop the service so that the service can perform any service specific activities necessary to stop the service. In general, this method undoes the work that the “start” method did. This method preferably completes and returns control to the Active Framework application in a timely manner.

Upgrader Hook Interface

The Upgrader hook interface includes methods to customize the upgrading or downgrading of a service. Preferably, a bundle writer implements this interface only if he or she wishes to perform some additional upgrade or downgrade related functions not performed by default during the upgrade or downgrade process by Active Framework. This interface includes the following exemplary method.

public boolean upgrade (URL nextURL, Object param) throws OperationAbortedException, OperationFailedException;

If the service in question implements this method, Active Framework invokes it during the upgrade or downgrade process to override any alternate or default upgrade or downgrade steps that would otherwise be performed if the hook was not present.

About Hook Interface

The About hook interface includes methods to query for “about” information for a service. Preferably, a bundle writer implements this interface only if he or she wishes to provide “about” attribute information to the Active Framework application.

public String getName ( );

public String getDescription ( );

public String getversion ( );

These methods provide different attributes of “about” information. The attributes that can be queried for include, but are not limited to, service name, description and version number.

Configurator Hook Interface

The Configurator hook interface is used by a bundle writer to make the bundle configurable. One exemplary method for implementing the Configurator hook interface is set out below.

public Object getConfigObject ( )

This method is called by Active Framework to ascertain the configuration object encapsulating access to configuration APIs (e.g., methods) of a bundle. In at least one embodiment, Active Framework uses what is known as a Java reflection mechanism, which allows looking for methods implemented by a class dynamically, to look for a specific method inside the object that it wants to call on the configuration object. Further, Active Framework may specify that all the methods implemented by this configuration object must take parameters that are of Java data-type ‘Object’ and return Object as return of the method viz. ‘Object method1 (Object val1, Object val2, . . . )

Bundle Packaging

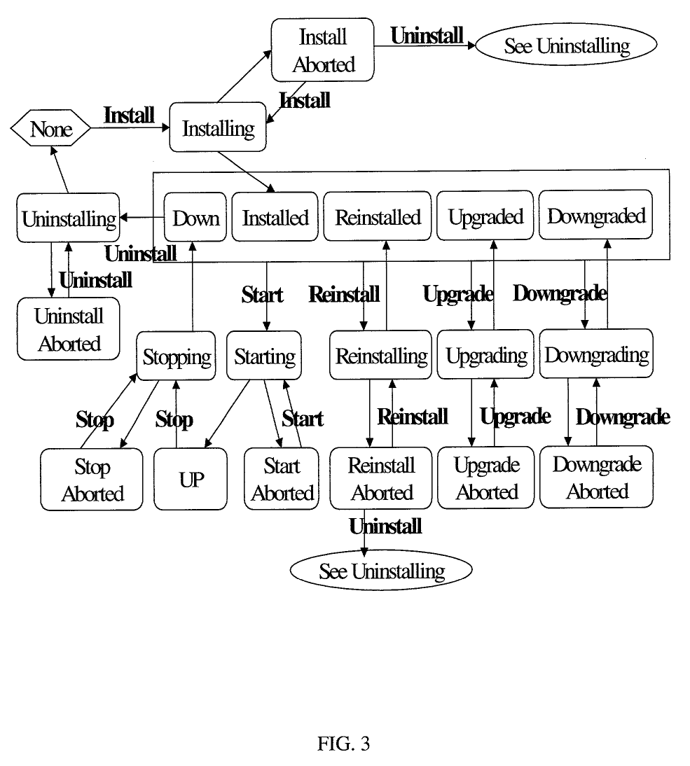

Referring now to FIG. 3, there is illustrated an exemplary embodiment of a bundle packaging. A bundle may contain many types of files. If the service packaged inside the bundle was originally developed in a programming language, e.g., C, C++, etc., then it may include one or more native modules (.o, .so or .dll files, for example, depending on the operating system in question). If the service included in the bundle is developed in Java only, then it would include class files. Since Active Framework is implemented in Java in one exemplary embodiment, the hook interfaces described above for a bundle are preferably available as Java classes. For a service that is not implemented in Java, these classes would be the bridge to the service. These Java classes and the class files or C-coded native modules of the service are packaged into a JAR file. As explained above, a bundle (JAR file) also includes a Manifest file that specifies the bundle information.

Service Life Cycle Operations

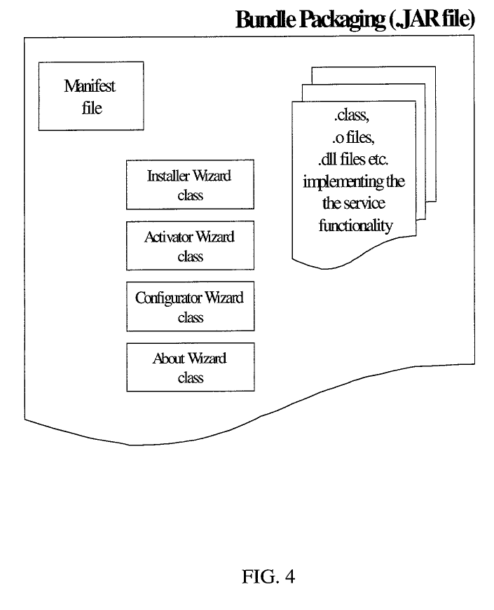

The life cycle of a service includes several states and transitions between those states. FIG. 4 depicts the various state transitions that a service may go through during various life-cycle operations. During its life cycle, a service may be in one of the following states:

INSTALLING—This state indicates that a service is being installed.

INSTALLED—This is the state after a service has been successfully installed.

INSTALL_ABORTED—This is the state after a service install could not be completed successfully and Active Framework was not able to recover the service state, e.g., the operational status of the service at a particular point of time, to the previous sane state, which in this case is none.

STARTING—This state indicates that the service is being started.

UP—This state indicates that a service has successfully started and is running.

START_ABORTED—This is the state after a service could not be started successfully and Active Framework was not able to recover the service state to the previous sane state (e.g., INSTALLED, DOWN).

STOPPING—This state indicates that the service is being stopped.

STOP_ABORTED—This is the state after a service could not be stopped successfully and Active Framework was not able to recover the service state to the previous sane state (UP in this case).

DOWN—This state indicates that a service was stopped from running (was earlier UP). This state is same as the INSTALLED state for all practical purposes.

REINSTALLING—This state indicates that the service is being reinstalled.

REINSTALL_ABORTED—This is the state after a service reinstall could not be completed successfully and Active Framework was not able to recover the service state to the previous sane state (e.g., INSTALLED).

UPGRADING—This state indicates that the service is being upgraded with a newer or later version.

UPGRADE_ABORTED—This is the state after a service upgrade could not be completed successfully and Active Framework was not able to recover the service state to the previous sane state (e.g., INSTALLED, DOWN).

DOWNGRADING—This state indicates that the service is being downgraded to some older or previous version.

DOWNGRADE_ABORTED—This is the state after a service downgrade could not be completed successfully and Active Framework was not able to recover the service state to the previous sane state (e.g., INSTALLED, DOWN).

UNINSTALLING—This state indicates that the service is being uninstalled.

UNINSTALL_ABORTED—This is the state after a service uninstall could not be completed successfully and Active Framework was not able to recover the service state to the previous sane state (e.g., INSTALLED, DOWN).

The following describes service life-cycle operations according to the present invention.

Installing A Service Bundle

A. Installing an Embedded Service on a Network Device Using a SMS

Referring to FIG. 12, when a new embedded service, e.g., a service bundle including a new embedded service, is available within a SMS, e.g., in its Services Repository where service bundles are stored/kept, and it is desired to install it on a network device, the SMS instructs Active Framework resident on the SMS (in the role of “Manager”) to install a network service on the network device.

In at least one embodiment, an exemplary method described below, is used by Active Framework resident on the SMS to instruct Active Framework resident on the network device to install a service bundle containing an embedded service on the network device.

public synchronized iActiveServiceDescriptor

installActiveService(URL url, String dirName, String serviceName) throws operationFailedException, OperationAbortedException

An exemplary embodiment of the “installActiveService” method provided by the Active Framework installs a service into Active Framework, e.g., the service is installed on a network device in the hosting environment provided by Active Framework. The service bundle is located at a specified URL location. The name of service is specified by serviceName. The directory where the service should be installed within Active Framework is specified by a dirName parameter. If this parameter is NULL, Active Framework automatically installs the service in a default install location. Once the service is installed, an instance of an ASD is created and returned to the caller application e.g., a remote SMS, by the install method. The rest of the life-cycle operations described below are performed using this ASD object.

Installing a service bundle within Active Framework is a persistent operation. This means that the service bundle remains installed across Active Framework invocations until it is explicitly uninstalled. In this context, Active Framework invocations are the specific instances of Active Framework each time it is activated.

The method returns an error to the caller application (by means of a Java mechanism of throwing a Java data-type “Exception” or a data-type derived from it) by throwing an OperationFailedException or OperationAbortedException in case of a failure or an error. If a failure occurs during the installation process, the method tries to bring Active Framework back to its previous sane state, which is the state of Active Framework before the install operation was started. If it succeeds in recovering the previous sane state, an OperationFailedException is thrown. If it fails, an OperationAbortedException is thrown. Either way, control is then returned to the Active Framework application.

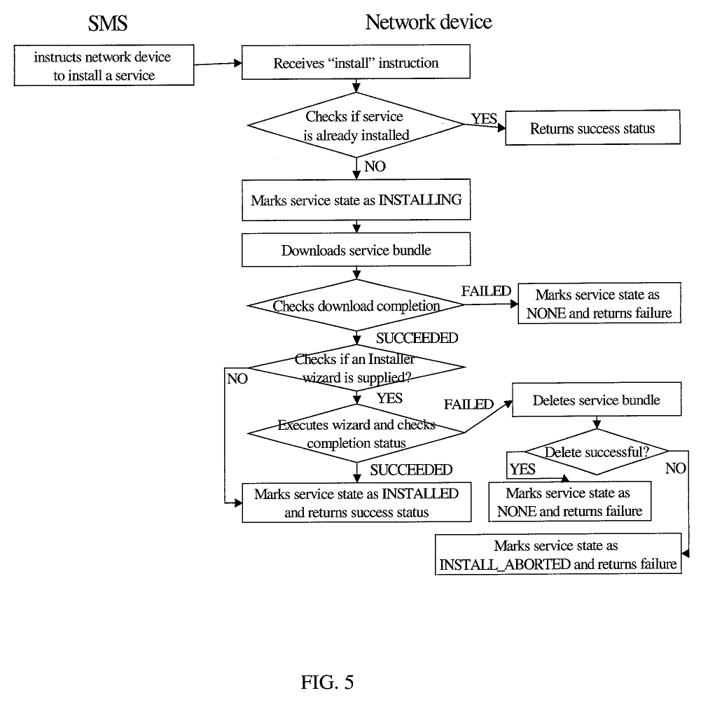

An exemplary embodiment of the “installActiveService” method, which is illustrated in FIG. 5, performs the following steps. All the parameters of the method are checked to determine if they are valid. If any parameter is invalid, an OperationFailedException is thrown. The exception indicates to the caller application, e.g., remote management application, that the installActiveService method resulted in a failure, and this particular service install attempt did not succeed. It is then up to the caller application to do whatever error handling it may deem appropriate. If the parameters are valid, a check is made to determine if a service with the same name and version number as the service being installed has already been installed into the current Active Framework environment. If so, an ASD object is instantiated and control returns with a success status to the caller application, which in this case, is typically a remote management application. If not, an ASD object is created.

The state of the bundle is then marked persistently as INSTALLING in Active Framework persistent (non-volatile) storage, which is hereafter referred to as the “Active Framework registry” or “AF registry.” In case of a failure, an OperationFailedException is thrown. If Active Framework goes down during installation of a bundle, when it comes up again, it can do the required clean up for the bundle (e.g., removing some of the files that may have been downloaded or copied in persistent storage, etc.) based on this state information. Active Framework can remove this state from persistent storage after doing the necessary clean up.

Next, the state of the bundle maintained in non-persistent memory is set to INSTALLING. The bundle is downloaded from the specified URL into persistent storage. If the bundle cannot be downloaded, however, the execution of the method is completed as described below. It should be noted that the service bundle download operation only involves receiving service bundle over network and storing the service bundle into the persistent storage (the file system of the network device) of the network device. New service capability is installed as a “self-contained” service in that the downloaded service bundle contains the complete code for the service capability. This operation does not affect other service capabilities provided by the network device. Therefore, regardless of the completion status of bundle download operation (i.e., whether it succeeded or failed), other services provided by the network device continue to run uninterrupted.

From the downloaded bundle, a check is made to determine if the bundle has an Installer hook that implements the “install” method. If so, the hook is invoked. If there is no hook, processing continues as described below. If a failure occurs, the execution of the method is completed as described below. In either case, the state of the bundle in the registry is marked to INSTALLED. It should be further noted that the code needed to invoke the hook by Active Framework is dynamically loaded for execution into the volatile memory of the network device (from the service bundle stored in the persistent storage of the network device in an earlier step) and then executed in a separate task context. Because the code of the service bundle is dynamically loaded and then executed in a separate task context, other service capabilities provided by network device remain completely unaffected and continue to run uninterrupted.

The execution of this method is then completed. If the installation was free of errors, the ASD created earlier is returned to the caller application. If there has been an error, attempts are made to undo any work performed by this method and an OperationFailedException is thrown. If the work cannot be undone, the state of the service in the AF registry is marked INSTALL_ABORTED and an OperationAbortedException is thrown. Control is then returned to the Active Framework application.

It should be noted that the service install operation is completed without interrupting the existing service capabilities provided by the network device. At least one embodiment of Active Framework uses Java language (on Windows NT, Solaris, Linux, VxWorks) to download the service bundle into the persistent storage of the network device and then to load the downloaded code of the service bundle dynamically into memory for execution in a separate Java thread (a separate task) context. However, it should be noted that it is possible to implement this concept using any of several other programming languages, including but not limited to C, C++, Ada, Smalltalk, etc., and on a variety of operating system platforms, including but not limited to Windows NT, Solaris, Linux, VxWorks, etc., all of which provide the ability to load code dynamically and to execute it in a separate task context.

B. Installing a Network Service on The Plurality of Network Devices Using a SMS

Referring again to FIG. 12, when a new network service, e.g., a service bundle including a new network service, is available within the SMS, e.g., in its Services Repository where service bundles are stored/kept, and it is desired to install the service on a plurality of network devices, the SMS instructs Active Framework resident on the SMS (in the role of “Manager”) to install that network service on the plurality of network devices. Active Framework then determines the embedded services (service capabilities destined for deployment on the plurality of network devices) comprising the network service, and the corresponding network devices on which these embedded services are to be installed. Further, Active Framework installs all embedded services to complete the installation of a network service on the corresponding network devices as explained below.

To install each embedded service on the corresponding network device, Active Framework resident on the SMS utilizes the “installActiveService” method (described above) to instruct Active Framework resident on the particular network device (in the role of “Network Device”) that a new service bundle (including embedded service) is available for download and installation on the network device. The location of the service bundle and the transport protocol, e.g., HTTP, FTP, etc., to download the bundle is passed along with the install instruction (e.g., specified as part of the URL parameter to “installActiveService” method) to the network devices. Upon receipt of the install instruction, Active Framework resident on network device downloads the service bundle from the specified location using the specified transport protocol, and installs it on the network device as per the “installActiveService” method described above. In this example, it should be noted that the new service capability is installed as a “self-contained” service. This means that the downloaded service bundle contains the complete code for the service capability. As explained above in the “Installing An Embedded Service On A Network Device . . . ” section, this allows installation of the service capability without disrupting existing running services on the network device. Further, as specified by Active Framework, the new service capability is installed as a “plug-in” service into the hosting environment provided by Active Framework. As explained below in the “Starting a service” and “Stopping a service” sections, this allows Active Framework to load or unload the service code dynamically, when required, to activate or deactivate the particular service without disrupting the other existing running services.

Once all embedded services are installed successfully, Active Framework (resident on the SMS) informs the SMS that network service installation was completed successfully. Active Framework sends a failure message to the SMS if the service installation failed.

Starting a Service

A. Starting an Embedded Service on a Network Device Using a SMS

Referring to FIG. 12, when it is desired to start an embedded service installed on a network device, the SMS instructs Active Framework resident on the SMS (in the role of “Manager”) to start that embedded service on a network device.

In at least one embodiment, an exemplary method described below, is used by the Active Framework resident on the SMS to instruct Active Framework resident on a network device to start an embedded service.

public void startActiveService(int serviceId) throws OperationFailedException,

OperationAbortedException

An exemplary embodiment of the “startActiveService” method of Active Framework starts the service specified by the given serviceId parameter. The method throws an OperationFailedException or an OperationAbortedException in case of a failure or error. In the case of a failure during the process of starting the service, the method tries to bring Active Framework back to its previous sane state. If it succeeds, an OperationFailedException is thrown, otherwise an OperationAbortedException is thrown.

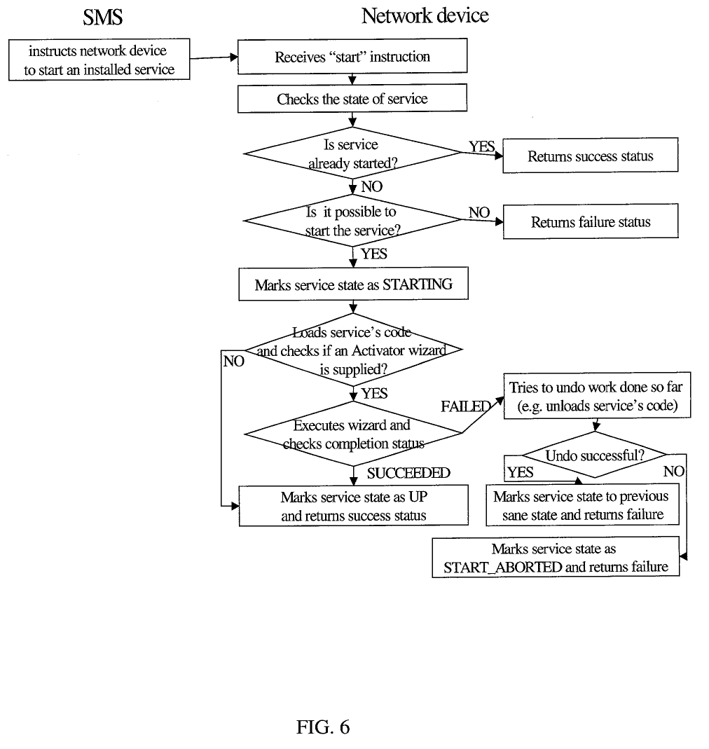

An exemplary embodiment of the “startActiveService” method, which is illustrated in FIG. 6, performs the following steps. First, a check is made to ascertain if the serviceId parameters are valid. If they are invalid, an OperationFailedException is thrown. By throwing an exception, the method passes information back to the application that invoked the method that the operation failed. The caller application then performs any necessary error handling.

If the parameters are valid, the service state is checked. If state of the service cannot be found, an OperationFailedException is thrown and control is returned to the caller application. If the service state is any of “'ING” states (e.g., INSTALLING, STARTING, etc.) or ABORTED states, except for START_ABORTED (e.g., INSTALL_ABORTED, STOP_ABORTED), an OperationFailedException is thrown and control is returned to the caller application. If the state of the service bundle is UP, the process returns control to the caller application with success status indicated.

Next, the state of the bundle is set to STARTING in the AF registry as well as in volatile storage. The contents of the service bundle are checked to determine if there is an Activator hook. If there is, the start method of the Activator hook is invoked. It should be noted that the code that is executed for invoking the hook (and activating the service capability) by Active Framework is loaded for execution into the memory of the network device dynamically from the “self-contained” service bundle stored in the persistent storage of the network device during service install as described earlier in the section entitled “Installing a service” and then executed in a separate in a separate task context. Because the code of the service bundle is loaded dynamically and then executed in a separate task context, other service capabilities provided by the network device remain completely unaffected and continue to run uninterrupted. If, however, an Activator hook is not supplied, the execution of the method is completed as described below.

After the Activator hook start method is complete, the state of the bundle is set to UP in the AF registry as well as in volatile storage. If for some reason Active Framework is restarted, it should automatically start the bundle again on the basis of this state information.

Finally, the execution of this installation process is complete. If the installation was free of errors, the process returns with success status to the caller application. If there has been an error, attempts are made to undo any work performed, an OperationFailedException is thrown and control is returned to the caller application. If the work cannot be undone, the state of the bundle in AF registry is marked to START_ABORTED, an OperationAbortedException is thrown and control is returned to the caller application.

It is important to note that service activation is completed without interrupting the existing service capabilities provided by the network device. As mentioned earlier in section entitled “Installing a service,” at least one embodiment of Active Framework uses Java language (on Windows NT, Solaris, Linux, VxWorks) for activating a service without interrupting other services provided by the network device. However, it should be noted that it is possible to implement this concept using any of several other programming languages, including but not limited to C, C++, Ada, Smalltalk, etc., and on a variety of operating system platforms, including but not limited to Windows NT, Solaris, Linux, VxWorks, etc., all of which provide the ability to load code dynamically and to execute it in a separate task context.

B. Starting a Network Service on the Plurality of Network Devices Using a SMS

Referring again to FIG. 12, when it is desired to start a network service installed on a plurality of network devices, the SMS instructs Active Framework resident on the SMS (in the role of “Manager”) to start that network service on a plurality of network devices. Active Framework then determines the embedded services comprising the network service, and the corresponding network devices on which these embedded services are installed. Further, Active Framework activates all embedded services to complete the activation of the network service on the corresponding network devices as explained below.

To activate each embedded service on the corresponding network devices, Active Framework resident on the SMS determines the service id for the embedded service, and then utilizes the “startActiveService” method (described above) to instruct Active Framework resident on the particular network device (in the role of a “Network Device”) to activate the embedded service. Upon receipt of the activate instruction, Active Framework resident on network device activates the embedded services as per the “startActiveService” method described above.

Once all embedded services are started successfully, Active Framework (resident on the SMS) informs the SMS that network service activation was completed successfully. Active Framework sends a failure message to the SMS if the service installation failed.

Stopping a Service

A. Stopping an Embedded Service on a Network Device Using a SMS

Referring again to FIG. 12, when it is desired to stop an embedded service running on a network device, the SMS instructs Active Framework resident on the SMS (in the role of “Manager”) to stop the embedded service. In at least one embodiment, an exemplary method described below, is used by the Active Framework resident on the SMS to instruct Active Framework resident on a network device to stop the running embedded service.

It should be noted that in the exemplary embodiment, a pre-existing service is stopped before any changes, modifications or alterations can be made to it. Only the service affected by any changes is stopped. All other services remain operational.

public void stopActiveService(int serviceId) throws OperationFailedException,

OperationAbortedException

An exemplary embodiment of the “stopActiveService” method of Active Framework stops the service specified by the given serviceId parameter. The method throws an OperationFailedException or an OperationAbortedException in case of a failure or error and control is returned to the caller application. If a failure occurs during the process of stopping the service, the method tries to bring Active Framework back to its previous sane state. If it succeeds, an OperationFailedException is thrown and control is returned to the caller application. If it fails, an OperationAbortedException is thrown and control is returned to the caller application.

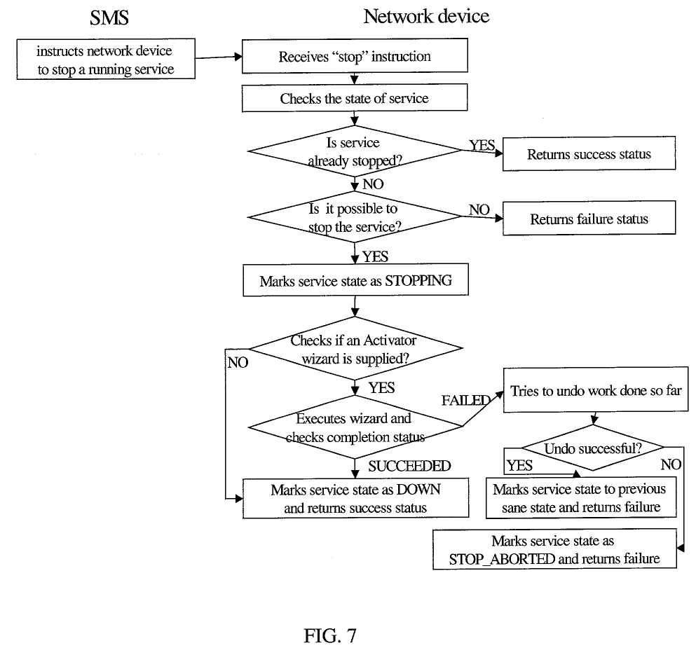

The exemplary embodiment of the “stopActiveService” method, which is illustrated in FIG. 7, performs the following steps. The service bundle is checked to determine if the serviceId parameters are valid. If they are invalid, an OperationFailedException is thrown and control is returned to the caller application.

If the parameters are valid, the service state of the bundle is checked. If the state of the service cannot be ascertained, an OperationFailedException is thrown and control is returned to the caller application. If the state of the service is any in one of the “'ING” states (e.g., INSTALLING, STARTING) or ABORTED states, except for STOP_ABORTED (e.g., INSTALL_ABORTED, START_ABORTED), an OperationFailedException is thrown and control is returned to the caller application. If the state of the bundle is DOWN (or INSTALLED, UPGRADED, DOWNGRADED, REINSTALLED for that matter), the process returns with success status to the caller application.

Next, the state of the bundle is set to STOPPING in the AF registry as well as in volatile storage. The contents of the bundle are checked to determine if it has an Activator hook. If it does, the Activator's “stop” method is invoked. As explained above in “Installing a service” and “Starting a service” sections, other service capabilities provided by the network device continue to run uninterrupted. If, however, an Activator hook is not supplied, the execution of the method is completed as described below. After the Activator hook stop method is complete, the state of the bundle is set to DOWN in the AF registry as well as in volatile storage.

Finally, the execution of this installation process is complete. If the installation was free of errors, the process simply returns with success status to the caller application. If there has been an error, attempts are made to undo any work performed by this process, an OperationFailedException is thrown and control is returned to the caller application. If the work cannot be undone, the state of the bundle in the AF registry is set to STOP_ABORTED, an OperationAbortedException is thrown and control is returned to the caller application.

B. Stopping a Network Service on the Plurality of Network Devices Using a SMS

Referring again to FIG. 12, when it is desired to stop a network service that is started or running on a plurality of network devices, the SMS instructs Active Framework resident on the SMS (in the role of “Manager”) to stop that network service on the plurality of network devices. Active Framework then determines the embedded services that comprises the network service and the corresponding network devices on which these embedded services are running. Further, Active Framework deactivates all embedded services to complete the deactivation of network service on the corresponding network devices as explained below.

To deactivate each embedded service on the corresponding network device, Active Framework resident on the SMS determines the service id for the embedded service, and then utilizes the “stopActiveService” method (described above) to instruct Active Framework resident on the particular network device (in the role “Network Device”) to deactivate the embedded service on the network device. Upon receipt of the deactivate instruction, Active Framework resident on network device deactivates the embedded services as per the “stopActiveService” method described above.

Once all embedded services are stopped successfully, Active Framework (resident on the SMS) informs the SMS that network service deactivation was completed successfully. If the deactivation of any of embedded services failed, Active Framework informs the SMS with a failure message.

Reinstalling a Service

A. Reinstalling an Embedded Service on a Network Device Using a SMS

Referring to FIG. 12, when it is desired to reinstall an embedded service that is already installed on a network device, the SMS instructs Active Framework resident on the SMS (in the role of “Manager”) to reinstall the embedded service on the network device.

In at least one embodiment, an exemplary method described below, is used by the Active Framework resident on the SMS to instruct Active Framework resident on network device to reinstall the embedded service.

public synchronized void reinstallActiveService( URL nextURL, int serviceId) throws OperationFailedException,

OperationAbortedException

The exemplary embodiment of the “reinstallActiveService” method of Active Framework reinstalls the service specified by the given serviceId parameter, whose code is suspected to be corrupted. The new service bundle is located at the specified URL location. The method throws an OperationFailedException or an OperationAbortedException in case of a failure or an error and control is returned to the caller application. If a failure occurs during the reinstallation process, the method tries to bring Active Framework back to its previous sane state. If it succeeds, an OperationFailedException is thrown and control is returned to the caller application. If it fails, an OperationAbortedException is thrown and control is returned to the caller application.

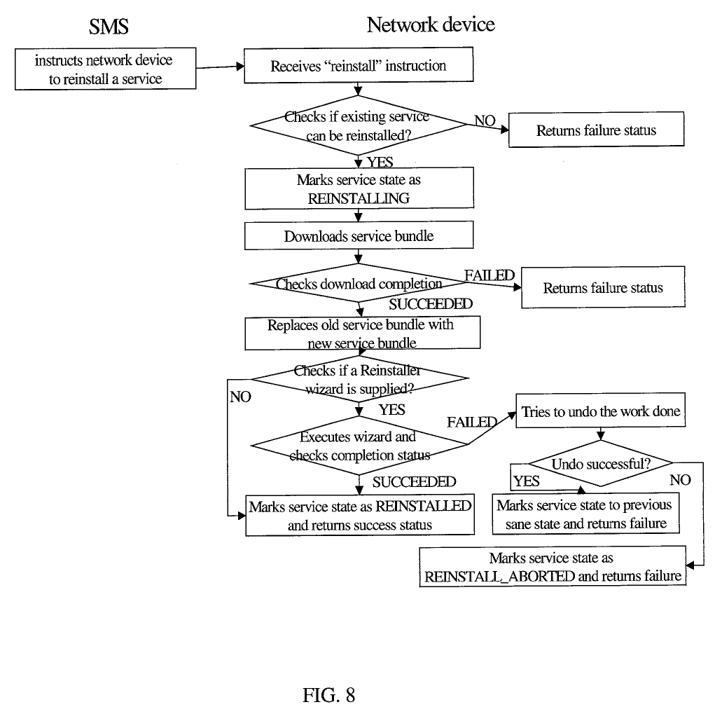

An exemplary embodiment of the “reinstallActiveService” method, which is illustrated in FIG. 8, performs the following steps. First, the parameters of the service bundle are checked to make sure they are valid. If any parameter is invalid, an OperationFailedException is thrown and control is returned to the caller application. Next, an attempt is made to locate the ASD for the service specified by serviceId. If it cannot be found, an OperationFailedException is thrown and control is returned to the caller application.

If the parameters are valid, a comparison is made to ascertain if the generic of the old service and the new service are the same. If they are not the same, an OperationFailedException is thrown and control is returned to the caller application. If they are the same, the service state is then checked. If the service state is not found, an OperationFailedException is thrown and control is returned to the caller application. If the service state is any of the “'ING” states (e.g., INSTALLING, STARTING) and ABORTED states, except for REINSTALL_ABORTED (e.g., INSTALL_ABORTED, START_ABORTED), an OperationFailedException is thrown and control is returned to the caller application.

The state of the bundle is marked persistently as REINSTALLING in the AF registry as well as in volatile storage. In case a failure occurs, an OperationFailedException is thrown and control is returned to the caller application.

Next, the bundle is downloaded from the specified URL into persistent storage overwriting any previously installed service bundle. If the bundle cannot be downloaded, the execution of the method is completed as described below.

From the downloaded bundle, a check is made to determine if the bundle has a Reinstaller hook that implements the “reinstall” method. If it does, the method is invoked. As explained above in “Installing a service” and “Starting a service” sections, other service capabilities provided by the network device continue to run uninterrupted. If not, the reinstall method continues. In case of any failure, the execution of the method is completed as described below. After the reinstall method is complete, the state of the bundle in the AF registry is marked to REINSTALLED.

Finally, the execution of this reinstallation process is complete. If the reinstallation was free of errors, the process simply returns with success status to the caller application. If an error occurred, attempts are made to undo any work performed by this process, an OperationFailedException is thrown and control is returned to the caller application. If the work cannot be undone, the state of the bundle is marked in the AF registry as REINSTALL_ABORTED, an OperationAbortedException is thrown and control is returned to the caller application.

B. Reinstalling a Network Service on the Plurality of Network Devices Using a SMS

Referring to FIG. 12, when it is desired to reinstall a network service that is already installed on a plurality of network devices, the SMS instructs Active Framework resident on the SMS (in the role of “Manager”) to reinstall that network service on the plurality of network devices. Active Framework then determines the embedded services that comprises the network service and the corresponding network devices on which these embedded services are installed. Further, Active Framework reinstalls all the embedded services to complete the reinstallation of network service on the corresponding network devices as explained below.

To reinstall each embedded service on the corresponding network devices, Active Framework resident on the SMS utilizes the “reinstallActiveService” method (described above) to instruct Active Framework resident on the particular network device (in the role “Network Device”) to reinstall the embedded service on the network device. Upon receipt of the reinstall instruction, Active Framework resident on network device reinstalls the embedded services as per the “reinstallActiveService” method described above.

Once all embedded services are reinstalled successfully, Active Framework (resident on the SMS) informs the SMS that network service reinstallation was completed successfully. If the reinstallation of any of embedded services failed, Active Framework informs the SMS with a failure message.

Upgrading a Service

A. Upgrading an Embedded Service on a Network Device Using a SMS

Referring to FIG. 12, when it is desired to upgrade an embedded service that is installed on a network device, the SMS instructs Active Framework resident on the SMS (in the role of “Manager”) to upgrade that embedded service with a newer version on the network device.

In at least one embodiment, an exemplary method described below is used by the Active Framework resident on the SMS to instruct Active Framework resident on network device to upgrade the embedded service.

public synchronized void upgradeActiveService( URL nextURL, int serviceId) throws OperationFailedException,

OperationAbortedException

The exemplary embodiment of the “upgradeActiveService” method of Active Framework upgrades the service specified by the given serviceId parameter. The new service bundle is located at the specified URL location. The method throws an OperationFailedException or an OperationAbortedException in case of a failure or error and control is returned to the caller application. If a failure occurs during the upgrade process, the method tries to bring Active Framework back to its previous sane state. If it succeeds, an OperationFailedException is thrown and control is returned to the caller application. If it fails, an OperationAbortedException is thrown and control is returned to the caller application.

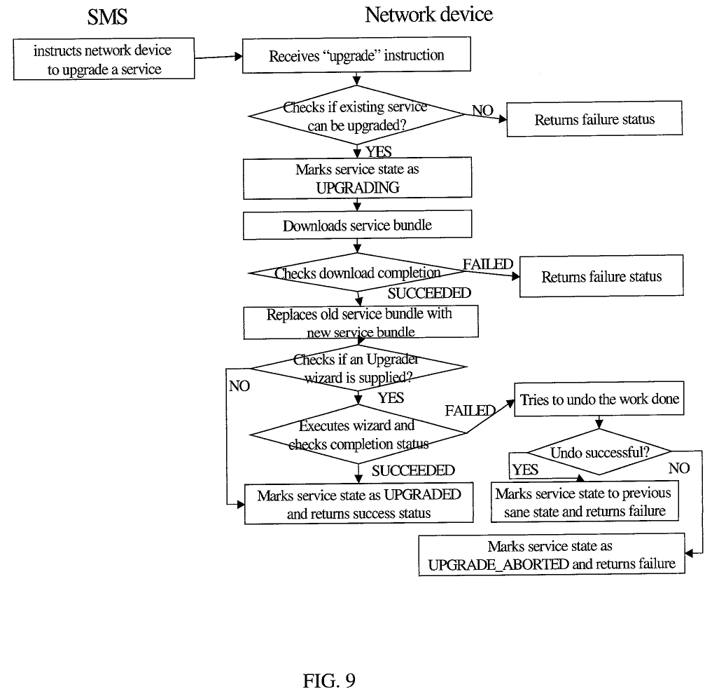

An exemplary embodiment of the “upgradeActiveService” method, which is illustrated in FIG. 9, performs the following steps. The method begins by examining the parameters of the service bundle to ascertain if they are valid. If any parameter is invalid, an OperationFailedException is thrown and control is returned to the caller application. If the parameters are valid, an attempt is made to obtain the ASD for the service specified by the serviceId parameter. If the ASD cannot be found, e.g., the AF registry has been corrupted, OperationFailedException is thrown and control is returned to the caller application. After locating the ASD, a comparison is made to determine if the generic of the old service and the new service are the same. If they are the same or if the new version is lower than the version of existing service, an OperationFailedException is thrown and control is returned to the caller application.

If they are not the same, the service state is next checked. An OperationFailedException is thrown if the service state cannot be found and control is returned to the caller application. Also, an OperationFailedException is thrown if the service state is in a state other than DOWN, INSTALLED, UPGRADED, DOWNGRADED, RESINSTALLED, or UPGRADE_ABORTED and control is returned to the caller application. It should be noted here that it is preferred that a service in an UP state (i.e., if it is running) should not be upgraded. If it is desired to upgrade an existing service capability on a network device, the service is preferably stopped first using “stopActiveService” method (described in section “Stopping a service” above).

The state of the bundle is marked persistently as UPGRADING in the AF registry as well as in volatile storage. If a failure occurs, an OperationFailedException is thrown and control is returned to the caller application. After marking the bundle, the bundle is downloaded from the URL specified in the bundle into persistent storage. If the bundle cannot be downloaded, the process completes as described below. Depending on the configuration, which is specified in an AF properties file, the previously installed service bundle is backed up. The backed up bundle is used by Active Framework to restore to a previous sane state in case of failure to install the new bundle successfully. Note that on network devices without sufficient persistent storage, Active Framework optionally can be configured not to backup the bundle for the existing service.

The downloaded bundle is examined to ascertain if it has an Upgrader hook that implements the “upgrade” method. If it does, the hook is invoked. As explained above in “Installing a service” and “Starting a service” sections, other service capabilities provided by the network device continue to run uninterrupted. In case of any failure occurring, the execution of the process is completed as described below. The state of the bundle in the AF registry is marked to UPGRADED.

Finally, the execution of this process is completed. If the installation was free of errors, process simply returns with success status to the caller application. If an error has occurred, the process attempts to undo any work performed, throws an OperationFailedException and control is returned to the caller application. If the work cannot be undone, the state of the bundle in the AF registry is marked to UPGRADE_ABORTED, an OperationAbortedException is thrown and control is returned to the caller application.

B. Upgrading a Network Service on the Plurality of Network Devices Using a SMS

Referring to FIG. 12, when a newer version of an existing network service, e.g., a newer version of a network service bundle, is available within the SMS, and it is desired to upgrade an existing network service deployed on plurality of network devices to this newer version, the SMS first determines whether the network service is activated/running (by making use of query support method “getAFStatus” described in “Queries Support” section below). If it finds that service is in an UP state (i.e., if service is running), the SMS instructs Active Framework resident on the SMS to stop the running network service as described earlier in section “Stopping a service.” It should be noted that this only stops those embedded services on network devices that constitute the network service that are to be upgraded. Other embedded services of the network devices are not affected and continue to run uninterrupted. The SMS then instructs Active Framework resident on the SMS (in the role of “Manager”) to upgrade that network service on the plurality of network devices. Active Framework then determines the embedded services that comprises the network service and the corresponding network devices on which these embedded services are installed. Further, Active Framework upgrades all the embedded services to complete the upgrade of network service on the corresponding network devices as explained below.

To upgrade each embedded service on the corresponding network device, Active Framework resident on the SMS utilizes the “upgradeActiveService” method (described above) to instruct Active Framework resident on the particular network device (in the role “Network Device”) to upgrade the embedded service on the network device. The location of the service bundle and the transport protocol, e.g., HTTP, FTP, etc., to download the bundle is passed along with upgrade instructions (specified as part of “URL” parameter to “upgradeActiveService” method) to the network devices. Upon receipt of the upgrade instruction, Active Framework resident on the network devices downloads the service bundle from the specified location using the specified transport protocol. Next, it replaces the existing service bundle with the downloaded new service bundle, and, optionally, also migrates configuration data with existing service capability to the new format that may be required by the newer version of service capability as per the “upgradeActiveService” method (described above).

Further, upon successful completion of the upgrade operation, the SMS makes use of the “startActiveService” method (described above) to activate the upgraded service capability. As previously described, other existing running services on the network devices continue to run uninterrupted when the new service bundle is downloaded, the existing service capability is upgraded, and the new service capability is activated.

Once all embedded services are upgraded and activated successfully, Active Framework (resident on the SMS) informs the SMS that the network service upgrade was completed successfully. If the upgrade of any of embedded services failed, Active Framework informs the SMS with a failure message.

Downgrading a Service

A. Downgrading an Embedded Service on a Network Device Using a SMS

Referring to FIG. 12, when it is desired to downgrade an embedded service installed on a network device, the SMS instructs Active Framework resident on the SMS (in the role of “Manager”) to downgrade that embedded service with an older version on the network device.

In at least one embodiment, an exemplary method described below is used by the Active Framework resident on the SMS to instruct Active Framework resident on network device to downgrade the embedded service.

public synchronized void downgradeActiveService( URL nextURL, int serviceId) throws OperationFailedException,

OperationAbortedException

The exemplary embodiment of the “downgradeActiveService” method of Active Framework downgrades the service specified by the given serviceId parameter. The new service bundle is located at the specified URL location. The method throws an OperationFailedException or an OperationAbortedException if a failure or an error occurs and control is returned to the caller application. In the case of a failure during downgrade process, the method tries to bring Active Framework back to its previous sane state. If it succeeds, an OperationFailedException is thrown and control is returned to the caller application. If it fails, an OperationAbortedException is thrown and control is returned to the caller application.

An exemplary embodiment of the “downgradeActiveService” method performs steps similar to those followed in the case of “upgradeActiveService.” The difference is that the service is being updated with a lower or older version and not a higher or newer version as in the case of “upgradeActiveService.”

B. Downgrading a Network Service on the Plurality of Network Devices Using a SMS

Referring to FIG. 12, when a network service installed on a plurality of network devices is to be downgraded, the SMS instructs Active Framework resident on the SMS (in the role of “Manager”) to downgrade that network service on the plurality of network devices. Active Framework then determines the embedded services that comprises the network service, and the corresponding network devices on which these embedded services are installed. Further, Active Framework downgrades all the embedded services to complete the downgrade of network service on the corresponding network devices as explained below.

To downgrade each embedded service on the corresponding network device, Active Framework resident on the SMS utilizes the “downgradeActiveService” method (described above) to instruct Active Framework resident on the particular network device (in the role “Network Device”) to downgrade the embedded service on the network device. Upon receipt of the downgrade instruction, Active Framework resident on network device downgrades the embedded services as per the “downgradeActiveService” method described above.

Further, upon successful completion of the downgrade operation, the SMS makes use of the “startActiveService” method (described above) to activate the downgraded service capability. As previously described, other existing running services on the network devices continue to run uninterrupted when the new service bundle is downloaded, the existing service capability is downgraded, and the new service capability is activated

Once all embedded services are downgraded and activated successfully, Active Framework (resident on the SMS) informs the SMS that network service downgrade was completed successfully. If the downgrade of any of embedded services failed, Active Framework informs the SMS with a failure message.

Uninstalling a Service

A. Uninstalling an Embedded Service on a Network Device Using a SMS

Referring to FIG. 12, when it is desired to uninstall an embedded service installed on a network device, the SMS instructs Active Framework resident on the SMS (in the role of “Manager”) to uninstall that embedded service on the network device.

In at least one embodiment, an exemplary method described below, is used by the Active Framework resident on the SMS to instruct Active Framework resident on network device to uninstall the embedded service.

public void unInstallActiveService( iActiveServiceDescriptor descriptor) throws OperationFailedException,

OperationAbortedException

The exemplary embodiment of the “unlnstallActiveService” method of Active Framework uninstalls the service specified by the given descriptor parameter. The method throws an OperationFailedException or an OperationAbortedException if a failure or error occurs and control is returned to the caller application. If a failure occurs during the un-installation process, the method tries to bring Active Framework back to its previous sane state. If it succeeds, an OperationFailedException is thrown and control is returned to the caller application. If it fails, an OperationAbortedException is thrown and control is returned to the caller application.

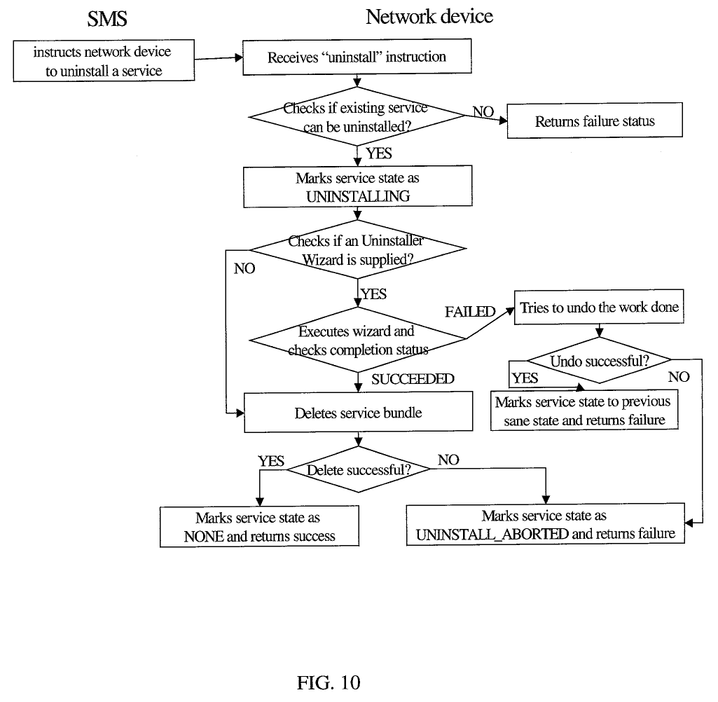

An exemplary embodiment of the “unlnstallActiveService” method, which is illustrated in FIG. 10, performs the following steps. First, the service state is examined. If it cannot be found, an OperationFailedException is thrown and control is returned to the caller application. Also, an OperationFailedException is thrown if the service state is any state other than DOWN, INSTALLED, UPGRADED, DOWNGRADED, RESINSTALLED, INSTALL_ABORTED, REINSTALL_ABORTED, and UNINSTALL_ABORTED and control is returned to the caller application.

Next, a check is made to determine if the service bundle has an Uninstaller hook that implements the “uninstall” method. If it does, the hook is invoked. As explained above in “Installing a service” and “Starting a service” sections, other service capabilities provided by the network device continue to run uninterrupted. Next, if the Uninstaller hook is not supplied or if hook was invoked and completed successfully, the JAR file of the service bundle and other persistent service resources (such as its configuration files, etc.) that the service was holding are deleted. If this fails, the execution of the process is completed as described below. Next, all entries for the service are removed from the AF registry.

Finally, the execution of this process is completed. If the uninstallation was error free, the process simply returns with success status to the caller application. If an error occurred, an attempt is made to undo any work performed by this method, an OperationFailedException is thrown and control is returned to the caller application. If the work cannot be undone, the state of the bundle in the AF registry is marked to UNINSTALL_ABORTED, an OperationAbortedException is thrown and control is returned to the caller application.

B. Uninstalling a Network Service on the Plurality of Network Devices Using a SMS

Referring to FIG. 12, when a network service installed on a plurality of network devices is to be uninstalled, the SMS instructs Active Framework resident on the SMS (in the role of “Manager”) to uninstall that network service on the plurality of network devices. Active Framework then determines the embedded services that comprises the network service, and the corresponding network devices on which these embedded services are installed. Further, Active Framework uninstalls all the embedded services to complete the uninstallation of network service on the corresponding network devices as explained below.

To uninstall each embedded service on the corresponding network device, Active Framework resident on the SMS utilizes the “uninstallActiveService” method (described above) to instruct Active Framework resident on the particular network device (in the role “Network Device”) to uninstall the embedded service on the network device. Upon receipt of the uninstall instruction, Active Framework resident on network device uninstalls the embedded services as per the “uninstallActiveService” method described above.

Once all embedded services are uninstalled successfully, Active Framework (resident on the SMS) informs the SMS that network service uninstallation was completed successfully. If the uninstallation of any of embedded services failed, Active Framework informs the SMS with a failure message.

Configuring a Service

In at least one embodiment, an exemplary method described below is used to configure a service.

Object invokeActiveServiceMethod(int serviceId, String methodName, Object[ ] params, boolean cfg) throws ActiveFrameworkInvalidStateException, ActiveServiceDoesntExistException,

ActiveServiceException, NoSuchMethodException,

IllegalAccessException, InvocationTargetException

The exemplary embodiment of the “invokeActiveServiceMethod” method of Active Framework configures the service specified by the given serviceId parameter. The service is configured by Active Framework by invoking the method specified by “methodName” parameter with the given parameter values specified by the “params” parameter on the service. The method throws one of the listed exceptions (in the method prototype above) in case of a failure or error and control is returned to the caller application.

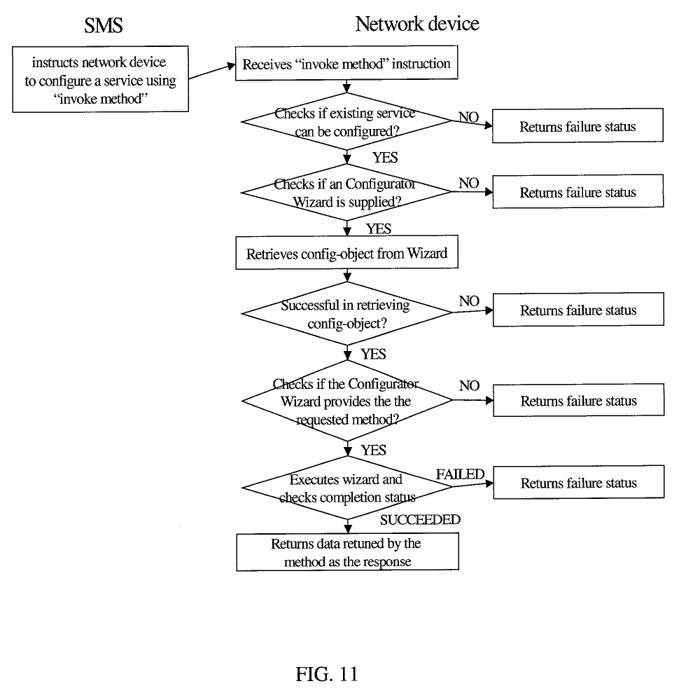

An exemplary embodiment of the “invokeActiveServiceMethod” method, which is illustrated in FIG. 11, performs the following steps. The first step of the method is to check the service state. If the service state cannot be found or if the service state is not UP, an ActiveServicelnvalidStateException is thrown and control is returned to the caller application.

If the state is found, the Main class hook for the bundle is retrieved. If a failure occurs during the retrieval, an ActiveServiceException is thrown and control is returned to the caller application. If the hook is successfully retrieved, the configuration object is retrieved from the Main class hook. If this step fails, an ActiveServiceException is thrown and control is returned to the caller application. Once the configuration object is retrieved, the configuration object is examined to determine if it implements a method matching with a given methodName and expected prototype (includes a number of input parameters, return-value, and their data types) using a Java reflection mechanism. If no such method is implemented by the configuration object, NoSuchMethodException is thrown and control is returned to the caller application. If the method is found, a method call is made on the configuration object. If a failure or an exception occurs when making the given method call, an “invokeActiveServiceMethod” method catches the exception and in turn throws the exception to the caller application. One of ActiveServiceException, InvocationTargetException, or IllegalAccessException can be thrown to the caller application by the “invokeActiveServiceMethod” method. The Object returned by the method—methodName—is returned to the caller application by the “invokeActiveServiceMethod.”

The previous section describes a generic method for an application (e.g., a SMS) to make any configuration request to any service that is deployed or installed on a network device in the hosting environment provided by Active Framework. Since a service could expose configuration APIs with any name and any number or type of parameters (depending on the configuration functionality that it wants to provide), such a generic mechanism at the Active Framework level is desirable. Configuring a service could, for example, mean adding rules to a firewall service, setting bandwidth limit for rate limiting service, adding a VPN policy for VPN service, etc.

Life Cycle Operations on Management Service Capabilities on a SMS

So far, it has described how Active Framework resident on the SMS and one or more network devices is used by the SMS to, among others, add, activate, upgrade, etc., the service capabilities on a plurality of network devices. Referring to FIG. 12, it should also be noted that it is possible to use Active Framework resident on a SMS in a similar way for the purpose of adding new management service capabilities, activating them, upgrading them, etc., on the SMS. When Active Framework is resident on a network device (in the role “Network Device”), a remote management application (e.g., Active Framework in the role of “Manager” resident on the SMS) is preferably used to instruct Active Framework to perform various operations such as installation, activation, upgrade, etc., of service capabilities on network devices. As Active Framework provides methods that can either be invoked by a local application or by a remote management application, at least one embodiment of the present invention uses the ability of invoking the methods of Active Framework locally through scripts (e.g., such as shell scripts on Unix, Solaris operating system platforms, .bat files on Windows operation system platforms, etc.) to instruct Active Framework resident on the SMS to install, activate, deactivate, upgrade, downgrade, reinstall or uninstall management service capabilities on the SMS itself. The scripts locally invoke the methods of Active Framework described above (e.g., installActiveService, startActiveService, upgradeActiveService, etc.) for performing these operations. It should be noted that the processes performed by Active Framework while performing operations on management service capabilities in a SMS are identical to the processes performed while doing the same or corresponding operations on service capabilities deployed on network device(s).

Active Framework Startup

In at least one embodiment, when Active Framework starts, it performs the following steps. First, it checks the state of all services in the AF registry. If the state of some service(s) is in an “'ING” state (e.g., INSTALLING, STARTING, etc.), this means some operations were in progress and could not be completed successfully when Active Framework went down last time. Active Framework tries to recover the service state back to a previous sane state, e.g., if it find some services in INSTALLING state, it tries to cleanup persistent resources (e.g., JAR files, etc.) of the service that may have been copied in Active Framework's persistent storage and marks the state of the service in the AF registry as if they were never installed. If it cannot do the required cleanup, it changes the state to <Operation>_ABORTED to indicate that the operation was aborted in between (e.g., if it finds a service in UPGRADING state, it sets the state to UPGRADE_ABORTED). Active Framework persistently maintains the configuration that specifies whether an installed service should (1) always be started when Active Framework comes up, (2) never be started when Active Framework comes up, or (3) only be started if it was UP before Active Framework went down last time (in an exemplary embodiment, this option is the default).

When Active Framework is restarted, it automatically tries to start all installed services that need to be started based on the above-mentioned configuration. This implies that if it fails in starting some service that it proceeds with the next. If Active Framework is running in the service gateway role, it sends a “connect” message to the configured the SMS to indicate that Active Framework has come up for the particular network device. As explained in the “Auto-Discovery Of Network Devices By A SMS” section below, the “connect” message also has additional information about the network device on which Active Framework is running. If running in the infrastructure manager role, this step is not executed.

Active Framework Shutdown

In at least one embodiment, when the Active Framework shuts down, it performs the following steps. If running in service gateway role, Active Framework sends a “disconnect” message to the configured SMS to indicate that Active Framework is going down. If running in the infrastructure manager role, this step is not executed.

Events Support

Active Framework generates events to inform the external world of important state changes taking place within its hosting environment. For instance, the Active Framework process generates notifications when it starts up or shuts down. Also, there are events that are generated during the life cycle of a service.

There are three kinds of events. The first are “Framework Events,” which are general Active Framework events that are generated by Active Framework when it starts, before it is shutdown and when some error occurs. Next are “Service Life-cycle Events,” which are service life-cycle events that are generated by Active Framework, e.g., (1) when a service is installed by Active Framework, (2) when a service is upgraded by Active Framework, (3) before a service is uninstalled by Active Framework, (4) when a service is started by Active Framework, and (5) before a service is stopped by Active Framework. Finally, “Service-specific events” are general service events that are generated by the service contained inside a bundle.

Queries Support

The following section describes methods that can be called by an application (e.g., a remote management application) to query certain attributes related to Active Framework or the services installed on a network device within the hosting environment provided by Active Framework. A remote management application is one that can remotely instruct Active Framework resident on network device to perform operations such as install, start, stop, etc. on services. A SMS is one example of a remote management application.

Getting Service Descriptors

The following exemplary method facilitates obtaining ASDs for all services installed into the hosting environment provided by Active Framework on a network device (or a SMS depending on where the method is invoked). The obtained ASDs can then be used to obtain various service attributes for the services.

public Vector getActiveServiceDescriptors ( )

This method returns to the caller application, e.g., the remote management application, a list of ASDs for services installed on the network device within the hosting environment provided by Active Framework. The ASDs can be used to query for other service attributes. Each ASD can be queried to get all attributes (see below) for the service represented by the ASD.

The following two exemplary methods facilitate obtaining an ASD for a given service Id or service name and version. The obtained ASD can then be used to obtain other service attributes.

public iActiveServiceDescriptor getActiveServiceDescriptor( int serviceId) throws ActiveServiceDoesntExistException

This method returns to the caller application an ASD for the service specified by given serviceId. It throws an ActiveServiceDoesntExistException if it cannot get the ASD for the service and control is returned to the caller application.

public iActiveServiceDescriptor getActiveServiceDescriptor( String name, String version) throws ActiveServiceDoesntExistException

This method returns to the caller application an ASD for the service specified by given name and version. It throws ActiveServiceDoesntExistException if it cannot get the ASD for the service and control is returned to the caller application.

Getting Attributes of a Service

The caller application can use the obtained ASD—with the help of either of the above methods—to make queries to get other attributes for the service represented by the ASD.

The following methods are provided by the ASD.

Getting Service ID

public String getID ( ) throws ActiveServiceDoesntExistException

This method returns the identifier of the service to the caller application. It throws ActiveServiceDoesntExistException if it cannot get ServiceId and control is returned to the caller application.

Getting Service Name

public String getName ( ) throws ActiveServiceDoesntExistException

This method returns the name of the service to the caller application. It throws ActiveServiceDoesntExistException if it cannot get service name and control is returned to the caller application.

Getting Service Version

public String getVersion ( ) throws ActiveServiceDoesntExistException

This method returns the version or generic of the service to the caller application. It throws ActiveServiceDoesntExistException if it cannot get service version and control is returned to the caller application.

Getting Service Download URL

public String getURL ( ) throws ActiveServiceDoesntExistException

This method returns the URL information for service bundle for the service to the caller application. It throws ActiveServiceDoesntExistException if it cannot get service URL and control is returned to the caller application.

Getting Service Install Location/Directory

public String getDataRoot ( ) throws ActiveServiceDoesntExistException

This method returns the “JAR file destination location” of the service within Active Framework to the caller application. It throws ActiveServiceDoesntExistException if it cannot get the JAR file destination location and control is returned to the caller application.

Getting Service Bundle's Filename

public String getJarName ( ) throws ActiveServiceDoesntExistException

This method returns the JAR file name with which the service bundle is installed in Active Framework to the caller application. It throws ActiveServiceDoesntExistException if it cannot get JAR file name and control is returned to the caller application.

Getting Service Bundle's Absolute Filename

public String getjarFileName ( ) throws ActiveServiceDoesntExistException

This method returns the Absolute JAR file name, which contains the path and the name of JAR file within Active Framework to the caller application. It throws ActiveServiceDoesntExistException if it cannot get Absolute JAR file name and control is returned to the caller application.

Getting a Service Hook

public iActiveServiceHook getHook (String hookName) throws ActiveServiceDoesntExistException,

ActiveServiceException, InstantiationException,

IllegalAccessException, InvocationTargetException,

ClassNotFoundException

This method returns the service hook specified by hookName parameter to the caller application. It throws one of the exception included in the method signature above if a failure or error occurs and control is returned to the caller application.

Getting Operational State of Services

public Vector getServicesStatus( ) throws Exception

This method returns a list of objects to the caller application. The attributes, which each Object contains, are Service Id, Name, Version and Operational Status. It throws an exception in case of an error or failure occurs and control is returned to the caller application.

Getting Active Framework Version Number

public String getVersion( ) throws Exception

This method returns the version number of Active Framework to the caller application. It throws an exception in case of an error or failure occurs and control is returned to the caller application

Getting Equipment Information

public Object getEquipmentInformation( ) throws Exception

This method returns information about the equipment on which Active Framework is running to the caller application. The Object returned as the return value may contain attributes such as equipment type, equipment software version number, equipment hardware number, etc. It should be noted that the contents of this object are implementation specific and, therefore, the specification of the exact contents of this Object do not form a part of the invention. At least one embodiment minimally provides equipment type, equipment software version number, and equipment hardware number attributes as part of this Object. The method throws an exception to the caller application in case of an error or failure occurs and control is returned to the caller application.

Auto-Discovery of Network Devices by a SMS

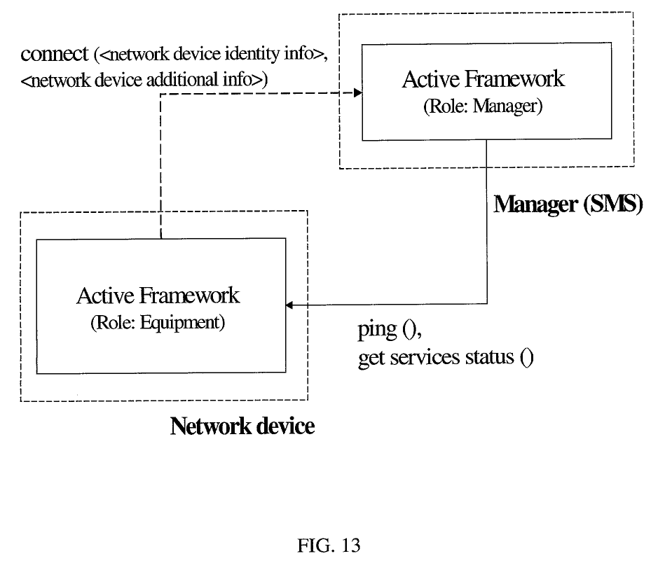

Referring now to FIG. 13, Active Framework resident on a SMS and Active Framework resident on a network device together enable the SMS to automatically discover network devices. This mechanism is referred to as “auto-discovery” and is explained below.

Active Framework resident on a network device is pre-configured (configured at installation time) with the identity of the SMS that is responsible for managing the network device. The identity information includes an IP Address of the machine (e.g., the Maestro platform available from Aplion Networks, computer, server, etc.) on which the SMS is running and a unique logical identifier of Active Framework resident on the SMS. When the network device comes up, Active Framework resident on it sends a “connect” message to Active Framework resident on the SMS using the SMS identity information that it has to indicate to the SMS that the network device has “come up.” The “connect” message includes information that identifies the network device uniquely (network device's IP address and unique logical identifier for Active Framework resident on the network device) and information such as a network device's hardware version number, its software version number, etc. If the SMS is not up, or is unreachable because of some intermittent network connection failure, Active Framework resends a “connect” message to the SMS after periodic intervals (as per a configurable scheme) unless it succeeds.

When Active Framework resident on the SMS receives the “connect” message, it extracts the identity information as well as other information about the network device from the “connect” message, and adds the network device to a list of auto-discovered network devices along with the complete information that it received as part of “connect” message. Referring to FIG. 13 again, Active Framework resident on the SMS then pings the network device using the network device's identity information that it received to verify the network device's operations status (that the network device is up). The SMS then, optionally, gets services status for the services installed on the network devices.

Determination of Operational Status of Network Devices and Services by a SMS

In addition to determining the operational status of network devices on a periodic basis, the SMS determines operational status of embedded services installed on the network devices by making use of the “getServicesStatus” method described above. Active Framework resident on the SMS can be configured to poll the operational status of embedded services on a periodic basis to enable the SMS to stay informed of the operational status of the services.

To determine the operational status of a network service, the SMS queries operational status of all embedded services that comprises the network service. The operational status of network service is then determined based on the individual operational status of the embedded services. For example, if the install operation of any of the embedded services failed, the operational status of network service is considered as “install failed.” Similarly, if the start operation of all embedded services succeeded, the start of the network service is considered to be a success.

Although the invention has been described and illustrated in the foregoing exemplary embodiments, it is understood that the present disclosure has been made only by way of example, and that numerous changes in the details of construction and combination and arrangement of processes and equipment may be made without departing from the spirit and scope of the invention as claimed below.

What is claimed:

1. A method for enabling the receipt and activation of a service capability by a network device, the network device operating in a network with other network devices to form a plurality of network devices to provide a plurality of services to at least one network user, the method comprising the steps of:
receiving a notification at the network device that at least one service bundle is available, the service bundle including the service capability for deployment on the plurality of network devices;
receiving the at least one service bundle at the network device without disrupting the plurality of services operating on the plurality of network devices; and
activating the service capability on the network device so that the service capability is available to the at least one network user without disrupting the operation of the plurality of services operating on the plurality of network devices.

2. The method according to claim 1 wherein prior to the step of activating the service capability, the method includes the step of installing the service capability on the plurality of network devices.

3. The method according to claim 1 wherein the service capability is a new service.

4. The method according to claim 1 wherein the service capability is a new version of one of the plurality of services provided by the plurality of network devices, further comprising the step of stopping the one of the plurality of services corresponding to the new version of the one of the plurality of services prior to the step of receiving the at least one service bundle.

5. The method according to claim 1 wherein the service capability is a new version of one of the plurality of services provided by the plurality of network devices, further comprising the step of stopping the one of the plurality of services corresponding to the new version of one of the plurality of services prior to the step of activating the service capability

6. The method according to claim 1 wherein the service capability is an older version of one of the plurality of services provided by the plurality of network devices, further comprising the step of stopping the one of the plurality of services corresponding to the older version of one of the plurality of services prior to the step of receiving the at least one service bundle.

7. The method according to claim 1 wherein the service capability is an older version of one of the plurality of services provided by the plurality of network devices, further comprising the step stopping the one of the plurality of services corresponding to the older version of one of the plurality of services prior to the step of activating the service capability.

8. The method according to claim 1 wherein the service capability is a new version of one of the plurality of services provided by the plurality of network devices, and wherein the step of activating the service capability comprises the steps of (1) stopping the one of the plurality of services corresponding to new version of the one of the plurality of services provided by the plurality of the network devices, (2) installing the new version of the one of the plurality of services, and (3) activating the new version of the one of the plurality of services.

9. The method according to claim 1 wherein the service capability is an older version of one of the plurality of services provided by the plurality of network devices, and wherein the step of activating the service capability comprises the steps of (1) stopping the one of the plurality of services corresponding to the older version of the one of the plurality of services provided by the plurality of network devices, (2) installing the older version of the one of the plurality of services, and (3) activating the older version of the one of the plurality of services.

10. A method for providing service capabilities to plurality of network devices, the plurality of network devices operating in a network to provide a plurality of services to at least one network user, the method comprising the steps of:
transmitting a notification to the plurality of network devices that at least one service bundle is available, the service bundle including a service capability for deployment on the plurality of network devices;
transmitting the at least one service bundle at the plurality of network devices without disrupting the plurality of services operating on the plurality of network devices; and
instructing the plurality of network devices to activate the service capability on the plurality of network devices so that the service capability is available to the at least one network user without disrupting the operation of the plurality of services operating on the plurality of network devices.

11. The method according to claim 10 wherein the service capability is representative of a new service.

12. The method according to claim 10 wherein the service capability is a new version of one of the plurality of services provided by the plurality of network devices, further comprising the step of stopping the one of the plurality of services corresponding to the new version of one of the plurality of services prior to the step of receiving the at least one service bundle.

13. The method according to claim 10 wherein the service capability is a new version of one of the plurality of services provided by the plurality of network devices, further comprising the step of stopping the one of the plurality of services corresponding to the new version of one of the plurality of services prior to the step of activating the service capability.

14. The method according to claim 10 wherein the service capability is an older version of one of the plurality of services provided by the plurality of network devices, further comprising the step of stopping the one of the plurality of services corresponding to the older version of the one of the plurality of services prior to the step of receiving the at least one service bundle.

15. The method according to claim 10 wherein the service capability is an older version of one of the plurality of services provided by the plurality of network devices, further comprising the step of stopping the one of the plurality of services corresponding to the older version of one of the plurality of services prior to the step of activating the service capability.

16. A network device capable of receiving and activating service capabilities, the network device operating in a network with other network devices to form a plurality of network devices to provide a plurality of services to at least one network user, the network device comprising:
means for receiving a notification that at least one service bundle is available, the service bundle including a service capability for deployment on the network device;
means for receiving the at least one service bundle without disrupting the plurality of services operating on the plurality of network devices; and
means for activating the service capability on the network device so that the service capability is available to the at least one network user without disrupting the operation of the plurality of services operating on the plurality of network devices.

17. A service management system capable of providing service capabilities to a plurality of network devices, the service management system coupled to the plurality of network devices by a network, the plurality of network devices operating in the network to provide a plurality of services to at least one network user, the service management system comprising:
means for transmitting a notification to the plurality of network devices that at least one service bundle is available, the service bundle including a service capability for deployment on the plurality of network devices;
means for transmitting the at least one service bundle to the plurality of network devices; and
means for instructing the plurality of network devices to activate the service capability on the plurality of network devices so that the service capability is available to the at least one network user without disrupting the operation of the plurality of services operating on the plurality of network devices.

18. A computer readable medium comprising a computer program for enabling the receipt and activation of a service capability by a network device, the network device operating in a network with other network devices to form a plurality of network devices to provide a plurality of services to at least one network user, by performing the steps of:
receiving a notification at the network device that at least one service bundle is available, the service bundle including the service capability for deployment on the plurality of network devices;
receiving the at least one service bundle at the network device without disrupting the plurality of services operating on the plurality of network devices; and
activating the service capability on the network device so that the service capability is available to the at least one network user without disrupting the operation of the plurality of services operating on the plurality of network devices.

19. A computer readable medium comprising a computer program for providing service capabilities to a plurality of network devices, the plurality of network devices operating in a network to provide a plurality of services to at least one network user, by performing the steps of:
transmitting a notification to the plurality of network devices that at least one service bundle is available, the service bundle including a service capability for deployment on the plurality of network devices;
transmitting the at least one service bundle at the plurality of network devices without disrupting the plurality of services operating on the plurality of network devices; and
instructing the plurality of network devices to activate the service capability on the plurality of network devices so that the service capability is available to the at least one network user without disrupting the operation of the plurality of services operating on the plurality of network devices.

20. A method of activating a service capability for a service management system, the service management system operating in a network with a plurality of network devices to manage the plurality of network devices, the service management system providing a plurality of management services to at least one network user, the method comprising the steps of:
receiving at least one service bundle at the service management system without disrupting the plurality of management services operating on the service management system, the service bundle including the service capability for activation on the service management system; and
activating the service capability on the service management system so that the service capability is available to the at least one network user without disrupting the operation of the plurality of management services operating on the service management system.

21. A service management system capable of receiving and activating service capabilities, the service management system operating in a network with a plurality of network devices to manage the plurality of network devices, the service management system providing a plurality of management services to at least one network user, the service management system comprising:
means for receiving the at least one service bundle without disrupting the plurality of management services operating on the service management system; and
means for activating the service capability on the service management system so that the service capability is available to the at least one network user without disrupting the operation of the plurality of management services operating on the service management system.

22. A computer readable medium comprising a computer program for activating a service capability for a service management system, the service management system operating in a network with a plurality of network devices to manage the plurality of network devices, the service management system providing a plurality of management services to at least one network user, by performing the steps of:
receiving at least one service bundle at the service management system without disrupting the plurality of management services operating on the service management system, the at least one service bundle including the service capability for deployment on the service management system; and
activating the service capability on the service management system so that the service capability is available to the at least one network user without disrupting the operation of the plurality of management services operating on the service management system.
